(19) United States
(12) Patent Application Publication
(10) Pub. No.: US 2011/0020512 A1
(43) Pub. Date: Jan. 27, 2011

(54) METHOD FOR ENHANCING FORM RETENTION PROPERTY OF BEVERAGE

(75) Inventors: Kenji MASUTAKE, Osaka (JP); Yasuharu SATO, Osaka (JP); Kazuhiko NISHIMURA, Osaka (JP)

Correspondence Address: KRATZ, QUINTOS & HANSON, LLP, 1420 K Street, N.W., 4th Floor, WASHINGTON, DC, 20005, US

(73) Assignee: SAN-EI GEN F.F.I., INC., Toyonaka-shi (JP)

(21) Appl. No.: 12/508,110

(22) Filed: Jul. 23, 2009

Related U.S. Application Data
(63) Continuation of application No. PCT/JP09/63071, filed on Jul. 21, 2009.

(51) Int. Cl. A23C 3/08; A23C 9/152; A23L 2/02

(52) U.S. Cl. 426/329; 426/569

(57) ABSTRACT

The present invention provides a method for enhancing a foam retention property of a beverage, and in addition a method for stably retaining foam in a beverage, the foam obtained by shaking the beverage, by enhancing the foam retention property. The present invention is implemented by preparing a beverage by using a fermentation-derived cellulose as a raw material thereof, more preferably by preparing a beverage by using a fermentation-derived cellulose in a state of complex with a high molecular substance.

### TECHNICAL FIELD

The present invention relates to a method for enhancing a foam retention property of a beverage. More specifically, the present invention relates to a method for enhancing a foam retention property of a beverage, thereby enabling foam in the beverage solution, the foam having been created by shaking the beverage, to be retained stably in the beverage.

### BACKGROUND ART

Conventionally, various methods have been studied for creating a smooth mouthfeel (texture) of beverages, such as cappuccino and milkshake, and for adding an excellent texture to the beverages by creating delicate foam on the top of or within coffee or milk.

As foaming methods, disclosed are, for example: (1) a method for obtaining foam by adding an emulsifier and ethyl alcohol to a beverage so as to be forcibly mixed with gas (Patent Document 1); (2) a method using, as an emulsifier, (a) either or both of a sorbitan mono saturated fatty acid ester and a propylene glycol fatty acid ester, and (b) at least one kind selected from the group consisting of a glycerol dibasic fatty acid ester, monoglyceride citrate, a polyglycerol fatty acid ester, and a sucrose fatty acid ester (Patent Document 2); (3) a method of adding, to a coffee extract, milk components in an amount that results in a milk fat content in a total amount of a coffee beverage equal to or more than 0.05 wt. %, together with a frothing agent (Patent Document 3); (4) a method of adding milk components, to a raw material liquid, during a milk-containing beverage manufacturing process, in an amount that results in a milk fat content in a total amount of the beverage equal to or less than 0.1 wt. %, together with a frothing agent (Patent Document 4); and (5) a method of filling a container with a beverage having a milk peptide and a water-soluble hemicellulose added thereto, and then shaking the mixture (Patent Document 5).

However, none of the methods have been satisfactory to create fine delicate foam not only in a top layer of a beverage solution but also within the beverage solution, or to stably retain the created foam within the beverage solution. In other words, with the above-described methods, there have been problems in that the foam created within the beverage solution quickly rises up to a surface of the beverage and it is difficult to retain the foam within the beverage solution, and that a smooth mouthfeel cannot be obtained since only the solution is poured while the foam remains inside a container of the beverage when the beverage is poured into a glass or when the beverage is to be drunk.

### [Citation List]

### [Patent Document]

[Patent Document 1] Japanese Unexamined Patent Publication No. H04-356160

[Patent Document 2] Japanese Unexamined Patent Publication No. H10-295339

[Patent Document 3] Japanese Unexamined Patent Publication No. H11-56244

[Patent Document 4] Japanese Unexamined Patent Publication No. 2000-60507

[Patent Document 5] Japanese Unexamined Patent Publication No. 2000-157232

### DISCLOSURE OF INVENTION

### Problems to be Solved by the Invention

The present invention has been developed in view of the above problems, and is aimed at providing a method of enhancing a foam retention property of a beverage, thereby enabling foam, having been created within a beverage solution, to be stably retained within the beverage solution.

### Solution to the Problems

The inventors have studied diligently so as to solve the above-described problems of conventional art, and have found that when a beverage is prepared by using a fermentation-derived cellulose as one of materials thereof, it is possible to create fine delicate foam (foaming) not only in a top layer of the beverage but also within the solution by shaking the beverage, and that the created foam is stably retained within the beverage solution for a long period of time. Further, it has been found that when the beverage having the foam created within the beverage is poured into another container or in a mouth, the foam is discharged together with the beverage solution.

Based on the findings, the inventors have verified that when a beverage is prepared by applying the above-described technology, it is possible to drink (take) the beverage having fine delicate foam included therein, and thus possible to prepare and provide a beverage having a smooth texture. Accordingly, the present invention has been achieved.

The present invention includes the following embodiments.

### (I) Method for Enhancing Beverage Foam Retention Property

(I-1) A method for enhancing a foam retention property of a beverage, the method including the step of: preparing the beverage using a fermentation-derived cellulose as a raw material thereof.

(I-2) The method for enhancing the foam retention property of the beverage described in (I-1), wherein, for preparation of the beverage, the fermentation-derived cellulose is complexed with a high molecular substance.

(I-3) The method described in (I-2), wherein the high molecular substance is at least one kind selected from the group consisting of xanthan gum, guar gum, carboxymethylcellulose, and a carboxymethylcellulose salt.

(I-4) The method described in any one of (I-1) to (I-3), wherein the beverage is prepared using a frothing agent as the other raw material.

(I-5) The method described in any one of (I-1) to (I-4), wherein the beverage is prepared using an emulsifier as the other raw material.

(I-6) The method described in (I-5), wherein the emulsifier is at least one kind selected from the group consisting of a sucrose fatty acid ester, a distilled monoglyceride, an organic acid monoglyceride, and quillaja extract.

(I-7) The method described in any one of (I-1) to (I-6), wherein the beverage is prepared using a polysaccharide as the other raw material.

(I-8) The method described in (I-7), wherein the polysaccharide is at least one kind selected from the group consisting of a microcrystalline cellulose, a soybean polysaccharide, xanthan gum, tamarind seed gum, pectine, carboxymethylcellulose, and a carboxymethylcellulose salt.

(I-9) The method described in any one of (I-1) to (I-8), wherein the beverage is a milk components-containing beverage, or a fruit or a vegetable beverage.

(I-10) The method described in any one of (I-1) to (I-9), wherein the fermentation-derived cellulose is used such that concentration of the fermentation-derived cellulose is in an amount of 0.04 to 0.2 wt. % in the beverage.

### (II) Method for Creating and Retaining Foam in a Beverage

(II-1) A method for creating and retaining foam in a beverage, comprising the step of shaking a container containing a beverage having a foam retention property enhanced based on any one of the methods described in (I-1) to (I-10), so as to create foam in the beverage.

(II-2) The method described in (II-1), wherein the beverage is a milk components-containing beverage, or a fruit or a vegetable beverage.

The invention according to (II-1) or (II-2) includes the meaning of “a method for preparing a foaming beverage”, and thus, the present invention includes “a method for preparing a foaming beverage”.

(II-3) The method for preparing a foaming beverage, comprising the step of shaking a container including a beverage having a foam retention property enhanced by any one of the methods described in (I-1) to (I-10), so as to create foam in the beverage.

(II-4) The preparation method described in (II-3), wherein the beverage is a milk components-containing beverage, or a fruit or a vegetable beverage.

### (III) Foaming Beverage

(III-1) A foaming beverage containing a fermentation-derived cellulose in a state of a complex with a high molecular substance, wherein a container containing the foaming beverage is shaken so as to create foam, and the foam is stably retained within the foaming beverage as well as in a top layer of the foaming beverage.

(III-2) The foaming beverage described in (III-1), wherein the high molecular substance is at least one kind selected from the group consisting of xanthan gum, guar gum, carboxymethylcellulose, and a carboxymethylcellulose salt.

(III-3) The foaming beverage described in (III-1) or (III-2), further containing a frothing agent.

(III-4) The foaming beverage described in any one of (III-1) to (III-3), further containing an emulsifier.

(III-5) The foaming beverage described in (III-4), wherein the emulsifier is at least one kind selected from the group consisting of a sucrose fatty acid ester, a distilled monoglyceride, an organic acid monoglyceride, and quillaja extract.

(III-6) The foaming beverage described in any one of (III-1) to (III-5), further containing a polysaccharide.

(III-7) The foaming beverage described in (III-6), wherein the polysaccharide is at least one kind selected from the group consisting of a microcrystalline cellulose, a soybean polysaccharide, xanthan gum, tamarind seed gum, pectine, carboxymethylcellulose, and a carboxymethylcellulose salt.

(III-8) The foaming beverage described in any one of (III-1) to (III-7), wherein the fermentation-derived cellulose is contained in an amount of 0.04 to 0.2 wt. % in the beverage.

(III-9) The foaming beverage described in any one of (III-1) to (III-8), wherein the foaming beverage is a milk components-containing beverage, or a fruit or a vegetable beverage.

### Effects of the Invention

According to the methods of the present invention, since the foam retention property of a beverage can be enhanced, it is possible to create fine delicate foam within the beverage solution, and also possible to stably retain the created foam within the solution for a long period of time. Therefore, when a beverage is prepared using the methods according to the present invention, by shaking the beverage as necessary before drinking, it is possible to easily prepare a beverage containing foam within the beverage and having an excellent texture (creamy texture).

### BEST MODE FOR CARRYING OUT THE INVENTION

### (I) Method for Enhancing Beverage Foam Retention Property

A method for enhancing a foam retention property according to the present invention can be implemented by using a fermentation-derived cellulose as one of the raw materials for preparing a beverage.

It is known that a fermentation-derived cellulose is used for preparing a beverage. For example, it is known that defibration products of cellulose (i.e., fermentation-derived cellulose) produced by acetic acid bacteria is used as a stabilizer for a water-based food product such as a beverage and a salad dressing (Japanese Unexamined Patent Publication No. S62-83854), and that the fermentation-derived cellulose is used for a milk beverage as a stabilizer for inhibiting creaming, oiling-off, and generation of white suspended matters and precipitation (Japanese Unexamined Patent Publication No. 2007-330256). However, there has been no example of usage of the fermentation-derived cellulose for preparing a foaming beverage for the purpose of enhancing the foam retention property of the beverage.

The fermentation-derived cellulose used in the present invention is not particularly limited, and may be any cellulose as long as the cellulose is produced by cellulose-producing bacteria. Normally, the fermentation-derived cellulose may be produced by culturing the cellulose-producing bacteria in accordance with a known method, for example, a method disclosed in Japanese Unexamined Patent Publications No. S61-212295, No. H03-157402, and No. H09-121787, and by isolating the cellulose-producing bacteria from the obtained culture or by appropriately purifying the obtained cellulose-producing bacteria if desired.

Examples of the cellulose-producing bacteria are bacteria belonging to genus Acetobacter, genus Pseudomonas, genus Agrobacterium and the like, but preferably genus Acetobacter. More specifically, examples of bacteria of the genus Acetobacter producing the fermentation-derived cellulose are Acetobacter pasteurianus (e.g., ATCC10245 and the like), Acetobacter sp. strain DA (e.g., FERMP-12924 and the like), and Acetobacter xylinum (e.g., ATCC23768, ATCC23769, ATCC10821, ATCC1306-21, and the like). A preferable example is Acetobacter xylinum.

A culture medium and a condition for culturing the cellulose-producing bacteria are not particularly limited, but may be determined in the usual manner. For example, the culture medium basically contains a nitrogen source, a carbon source, water, oxygen, and other necessary nutrients, and enables the above-described microorganisms to proliferate, to thereby produce the target fermentation-derived cellulose. Hestrin-Schramm culture medium is an example of the culture medium. In order to improve the productivity of the cellulose, a partial decomposition product of the cellulose, inositol, a phytic acid, and the like may be added to the culture medium (Japanese Unexamined Patent Publications No. S56-46759 and H05-1718). As culturing conditions, pH 5 to 9 and a culture temperature ranging from 20 to 40° C. are applied, for example. The culturing is continued until a sufficient amount of fermentation-derived cellulose is produced. Any of static culturing, agitation culturing, and aeration culturing may be used as a culturing method, and aeration-agitation culturing may be preferably used.

In order to produce a large amount of fermentation-derived cellulose, a multi-stage inoculation method is preferably conducted. In this case, normally, a five-stage fermentation process including two-stages of preliminary inoculation processes, a primary inoculation-fermentation process, a secondary inoculation-fermentation process, and a final fermentation process is adopted. Bacteria proliferated in each process are examined so as to confirm morphology of cells and of being gram-negative, and are then passed into a fermentator in a subsequent process.

After fermentation, the produced fermentation-derived cellulose is separated from the culture medium, washed, and then purified, accordingly. A method for purification is not particularly limited, but usually used is the following method. That is, the fermentation-derived cellulose collected from the culture medium is washed, dehydrated, and then is mixed with water again to make slurry. The slurry is treated with alkali to remove microorganisms, and then a dissolved matter generated through the alkali treatment is removed. A specific example of the method will be described below.

First, a culture obtained by culturing microorganisms is dehydrated to make a cake having a solid content of about 20%. The cake is mixed with water to make slurry again so as to adjust the solid content to 1 to 3%. Sodium hydroxide is added to the resultant slurry in order to adjust the pH to about 13, and then the whole mixture is heated at 65° C. for several hours while being agitated, to thereby dissolve the microorganisms. Next, the pH of the resultant slurry is adjusted to a range of 6 to 8 with a sulfuric acid, and the slurry is dehydrated and then mixed with water so as to make slurry again. The dehydrating and slurrying are repeated several times. The purified fermentation-derived cellulose may be subjected to a drying process if necessary. The drying process is not particularly limited, but any known process such as natural drying, heated-air drying, freeze-drying, spray drying, drum drying, and the like may be used. The spray drying method and the drum drying method are preferred.

The fermentation-derived cellulose obtained as above is a substance of a white to yellowish brown color, and is composed of very fine fibrous particles which can be quickly dispersed into water. Note that the fermentation-derived cellulose used in the present invention is not necessarily limited by the preparation method, as long as the fermentation-derived cellulose has properties identical or similar to those of the fermentation-derived cellulose prepared by using the above method, and is capable of achieving the object of the present invention.

In the method of the present invention, the ratio of the fermentation-derived cellulose to be blended with a beverage may be in a range that is capable of achieving an effect of the present invention, and may be adjusted according to the type of the beverage. Usually, the ratio of the fermentation-derived cellulose may be selected from or adjusted in a range from 0.01 to 0.4 wt. % in 100 wt. % of a final beverage, and is preferably in a range from 0.02 to 0.2 wt. %.

In the present invention, the fermentation-derived cellulose maybe used solely, or may be used in combination with another high molecular substance. In the case of a combination use with the high molecular substance, the fermentation-derived cellulose may be used in a state of a complex with the high molecular substance.

Two methods disclosed in Japanese Unexamined Patent Publications No. H09-121787 are examples for compounding the fermentation-derived cellulose with the high molecular substance.

In the first method, in order to produce the fermentation-derived cellulose by culturing microorganisms, a high molecular substance is added to a culture medium, whereby a fermentation-derived cellulose complex is obtained as a result of compounding of the fermentation-derived cellulose with the high molecular substance.

In the second method, a gel made from the fermentation-derived cellulose produced by culturing microorganisms is immersed in a high molecular substance solution, and the gel from the fermentation-derived cellulose is impregnated with the high molecular substance, to thereby produce the complex. The gel of the fermentation-derived cellulose is used as it is, or is subjected to a homogenization process based on an ordinary method, and is then immersed in the high molecular substance solution. The homogenization process may be based on a known method. For example, a mechanical dissociating process such as a process using a blender, a process using a high-pressure homogenizer performed about 40 times under a pressure of 500 kg/cm², a process using a nanomizer performed about three times under a pressure of 1000 kg/cm², and the like is effective. The immersing time is not limited, but is in a range from 30 minutes to about 24 hours, and is preferably one night long. Upon completion of immersion, it is preferable to remove the immersion liquid by using a method such as centrifugal separation or filtration. Further, when an excessive amount of the high molecular substance is removed by a process such as washing with water and the like, the fermentation-derived cellulose complexed with the high molecular substance is obtained, and it is also possible to prevent an effect of the high molecular substance remaining without being complexed.

Examples of the high molecular substance used to be complexed with the fermentation-derived cellulose are xanthan gum, carrageenan, galactomannan (guar gum, locust bean gum, tara gum, and the like), cassia gum, glucomannan, native gellan gum, deacylated gellan gum, tamarind seed gum, pectine, psylium seed gum, gelatine, tragacanth gum, karaya gum, arabic gum, ghatti gum, macrophomopsis gum, agar, an alginic acid-related substance (alginic acid and alginate), curdlan, pullulan, methylcellulose (MC), hydroxypropyl methylcellulose (HPMC), carboxymethylcellulose (CMC) or a salt thereof, hydroxypropyl cellulose (HPC), a cellulose derivative such as hydroxyethyl cellulose (HEC), a microcrystalline cellulose, a water-soluble hemicellulose, a soybean polysaccharide, a processed or a modified starch, and a non-processed (raw) starch.

These substances may be used solely, or two or more of these substance may be arbitrarily combined to be used.

Preferable examples of the high molecular substance are xanthan gum, galactomannan, and carboxymethylcellulose (CMC) or a salt thereof. A preferable example of the galactomannan is guar gum, and a preferable example of the CMC salt is a CMC sodium salt. More preferably, as the high molecular substance, either of xanthan gum or guar gum is used in combination with CMC or a CMC salt.

In the method of the present invention, the fermentation-derived cellulose is more preferably used in a state of a complex with at least one high molecular substance selected from the group consisting of xanthan gum, galactomannan (guar gum, particularly), carboxymethylcellulose (CMC), and a CMC salt. Further more preferably, the fermentation-derived cellulose is used by being complexed with at least one substance selected from the group consisting of a galactomannan (guar gum, particularly), carboxymethylcellulose (CMC), and a CMC salt. With the use of the fermentation-derived cellulose complexed as above, it is possible to optimally create fine delicate foam within a beverage, and also possible to retain the created foam within the beverage solution in a stable manner.

The fermentation-derived cellulose complexed with the above-described high-molecular compound is commercially available, and examples thereof are San Artist (trademark registered in Japan) PX (a preparation obtained by compounding a fermentation-derived cellulose with xanthan gum and a CMC sodium salt) and San Artist (trademark registered in Japan) PG (a preparation obtained by compounding a fermentation-derived cellulose with guar gum and a CMC sodium salt) which are manufactured by San-Ei Gen F. F. I., Inc.

In the method of the present invention, when the fermentation-derived cellulose is used in a form of the fermentation-derived cellulose complex in combination with the high molecular substance, a ratio of the fermentation-derived cellulose to be blended in a beverage is usually 0.01 to 0.4 wt. %, but preferably 0.02 to 0.2 wt. % in 100 wt. % of a final beverage, whereas the ratio of the high molecular substance is usually 0.001 to 0.3 wt. %, but preferably 0.002 to 0.15 wt. % in 100 wt. % of the final beverage. When at least one of xanthan gum, guar gum, and a CMC sodium salt is used as the high molecular substance, the ratio of the xanthan gum or guar gum may be 0.0005 to 0.15 wt. %, but preferably 0.001 to 0.075 wt. % in 100 wt. % of the final beverage, whereas the ratio of the CMC sodium salt may be 0.0005 to 0.15 wt. %, but preferably 0.001 to 0.075 wt. %. In this case, the ratio of the fermentation-derived cellulose to the high molecular substance in the fermentation-derived cellulose complex is 3:1 to 1:2, preferably 2:1 to 1:1, and more preferably 3:2.

Further, within the scope that does not inhibit the effect of the present invention, in addition to the fermentation-derived cellulose or to the complex of the fermentation-derived cellulose and the high molecular substance, a polysaccharide may be used as a raw material for beverage preparation. By using the polysaccharide, it is possible to change a mouthfeel of the foam in the beverage. Examples of the polysaccharide are xanthan gum, carageenan, galactomannan (guar gum, locust bean gum, tara gum, and the like), cassia gum, glucomannan, native gellan gum, tamarind seed gum, pectine, psylium seed gum, gelatine, tragacanth gum, karaya gum, gum arabic, ghatti gum, macrophomopsis gum, agar, alginic acid, an alginic acid-related substance (alginate), pullulan; cellulose derivatives such as methylcellulose (MC), hydroxypropyl methylcellulose (HPMC), carboxymethylcellulose (CMC) or a salt thereof, hydroxypropyl cellulose (HPC), hydroxyethyl cellulose (HEC), a microcrystalline cellulose, a water-soluble hemicellulose; a soybean polysaccharide, a processed or a modified starch, and a non-processed (raw) starch. Among above, preferable examples are a microcrystalline cellulose, a soybean polysaccharide, xanthan gum, tamarind seed gum, pectine, and carboxymethylcellulose or a salt thereof. Any one of these substances may be used solely, or two or more of these substances may be arbitrarily combined and used.

When the above-described polysaccharide is used, the ratio of the polysaccharide to be blended with a beverage is 0.01 to 1 wt. %, preferably 0.02 to 0.5 wt. % in 100 wt. % of a final beverage.

Further, within the scope that does not inhibit the effect of the present invention, in addition to the fermentation-derived cellulose or to the complex of the fermentation-derived cellulose and the high molecular substance, a frothing agent may be used as a raw material for beverage preparation. Examples of the above-described frothing agent are milk components, a protein or a protein hydrolysate, a polysaccharide, and an emulsifier. Nonfat dry milk is a preferable example of the milk components.

Examples of the protein or protein hydrolysate are egg white proteins, soy proteins, gluten, wheat proteins, gelatine, whey proteins such as a whey protein concentrate or a purified whey protein, sodium casein, or hydrolysates of the above-described substances.

Still further, within the scope that does not inhibit the effect of the present invention, in addition to the fermentation-derived cellulose or to the complex of the fermentation-derived cellulose and the high molecular substance, an emulsifier may be used as a raw material for beverage preparation. By using the emulsifier, it is possible to change a mouthfeel of the foam, and also possible to cause the foam to be retained for a further longer period of time.

Examples of the emulsifier are a glycerol fatty acid ester (a monoglycerol fatty acid ester, a diglycerol fatty acid ester, an organic acid monoglyceride, a distilled monoglyceride, a polyglycerol fatty acid ester, and polyglycerol esters of interesterified ricinoleic acid), a sucrose fatty acid ester, a sorbitan fatty acid ester, a propylene glycol fatty acid ester, lecithin, quillaja extract, saponin, and polysorbate. Preferable examples of the emulsifier are a distilled monoglyceride, a sucrose fatty acid ester, an organic acid monoglyceride (succinylated monoglyceride, particularly), and quillaja extract. The HLB of the emulsifier may be in a range from 3 to 20, preferably in a range from 3.5 to 16. When the above-described emulsifier is used, the ratio of the emulsifier to be blended with a beverage is 0.01 to 1 wt. %, preferably 0.03 to 0.4 wt. % in 100 wt. % the final beverage.

Further, within the scope that does not inhibit the effect of the present invention, in addition to the fermentation-derived cellulose or to the complex of the fermentation-derived cellulose and the high molecular substance, a salt may be used as a raw material for beverage preparation. Any kind of salts may be used as long as it is edible, and examples of the salt are a sodium salt, a potassium salt, a calcium salt, and a magnesium salt of an inorganic acid (a hydrochloric acid, a sulfuric acid, a phosphoric acid, a carbonic acid, and the like), and of an organic acid (e.g., an oxalic acid, a citric acid, a malic acid, a lactic acid, an ascorbic acid, and the like). Preferable examples are sodium polyphosphate, tripotassium phosphate, dipotassium hydrogen phosphate, and trisodium citrate, and a more preferably example is trisodium citrate. These kinds of salts may be used solely, or two or more kinds of salts may be arbitrary combined and used. When the above-described salt is used, the ratio of the salt to be blended with a beverage is 0.01 to 0.3 wt. %, preferably 0.05 to 0.2 wt. % in 100 wt. % of the final beverage.

The beverage to be targeted in the present invention is not particularly limited, and a fruit beverage, a vegetable beverage, a beverage containing milk components are examples of the beverage.

Examples of the milk components are milk, nonfat dry milk, dry whole milk, concentrated milk, dairy cream, condensed milk, butter, nonfat milk, a cream powder, a sweetened milk powder, a modified milk powder, a whey powder, and a butter milk powder. Preferable examples are nonfat a dry milk and a whey powder. The ratio of the milk components contained in the beverage is equivalent to 0.5 to 10 wt. % of non-fat milk solid content, preferably 1 to 5 wt. %, and more preferably 2 to 4 wt. %. Further, the method of the present invention is preferably used for a milk components-containing beverage having a fat content of 0 to 5 wt. %, preferably 0.02 to 1 wt. %.

Further, the fruit beverage to be targeted by the present invention includes a concentrated fruit juice (beverage obtained by concentrating and reconstituting extracted fruit juice), a fruit juice (beverage obtained by reconstituting extracted fruit juice or concentrated fruit juice), a mixed fruit juice (beverage made from two or more fruits), a fruit juice containing pulp (beverage obtained by adding finely sliced citrus juice vesicle or fruit pulp in an amount equal to or less than 30% of the beverage), a fruit and vegetable mixed juice (beverage obtained by mixing fruit and vegetable, and containing fruit in an amount equal to or more than 50% of the beverage), a beverage containing fruit juice (having a fruit juice content in a final drinking beverage equal to or more than 10%), and a beverage containing low-concentration fruit juice (having a fruit juice content in a final drinking beverage less than 10%). Still further, the vegetable beverage to be targeted by the present invention includes a beverage containing a single or several vegetables as its raw materials, and a beverage containing a vegetable and a fruit as its raw materials.

The pH of the beverage is not particularly limited, and is usually in a range from pH 3.3 to 7.5, but preferably in a range from pH 3.5 to 7, which is acidic or neutral.

Specific preferable examples of the beverage containing the milk components targeted by the present invention are: milk beverages such as a coffee-milk beverage (coffee containing milk), milk tea (tea containing milk), milk, milkshake, cocoa milk, strawberry milk, a acidic milk beverage, and the like; tea beverages containing milk components such as green tea containing milk, Matcha containing milk, and the like; fruit juice and fruit beverages containing milk such as strawberry milk, banana milk, melon milk, a smoothie, and the like; a soup containing milk components such as cream soup and the like; acidic milk beverages such as a yogurt beverage, a lactic acid beverage, a acidic milk beverage, and the like. Among these beverages, a coffee-milk beverage, milk tea, milkshake, milk-containing Matcha, an acidic milk beverage are preferable.

In the beverage for the present invention, a water-insoluble solid content may be contained. Examples of the water-insoluble solid contents are a Matcha powder, cocoa, cacao mass, a soybean powder, adzuki-beans, jelly, pearl tapioca, powdered calcium, sesame grains, powdered or pasted sesame, puree of a vegetable and a fruit, juice vesicle, or pulp, and the like. Examples of beverages containing the water-insoluble solid contents are a Matcha beverage, a cocoa beverage, cocoa shake, a jelly-containing beverage, a calcium-enhanced beverage, a puree-containing beverage, a beverage containing juice vesicle or pulp of a vegetable or a fruit, tapioca tea, tapioca milk, and the like. These various beverages further include a milk beverage which contains milk components.

The type of a container to be filled with the above-described beverages is not particularly limited, and examples of the container are a steel can, a paper pack, a glass bottle, a polyethylene terephthalate bottle (PET bottle), an aluminum can, and the like. Usually, a potable liquid, preferably a beverage is poured into a container up to 30 to 90 volume %, but preferably up to about 50 to 70 volume % of a total volume of the container so as to keep a space which facilitates foam creation when the container is shaken. The amount to be poured may be changed accordingly in accordance with a beverage to be prepared. For example, when a foaming coffee-milk beverage is to be prepared, the amount of the beverage to be poured into a container is about 70 to 90 volume %, and when a shake-like beverage is to be prepared, the amount thereof to be poured is about 30 to 50 volume %. In this manner, the amount of the beverage to be poured can be changed in an arbitrary range.

A method for producing the beverage to be targeted by the present invention is not limited. For example, a beverage can be prepared as follows: at least the above-described fermentation-derived cellulose is dissolved in water together with other raw materials; a raw material such as a coffee extract, a tea extract, a fruit constituent, or the like, which is separately extracted, is added depending on the type of the beverage; the pH of the mixture is adjusted if necessary; the mixture is subjected to homogenization; and the beverage is poured into a container. In the case of a beverage containing milk components, the beverage is prepared by dissolving the fermentation-derived cellulose in water together with other raw materials, and by adding, to the mixture, the milk components and then a raw material depending on the type of the beverage. Usually, the beverage is subjected to a sterilization process after poured into a container. The sterilization process is not particularly limited, and any method such as retort sterilization, plate sterilization, autoclave sterilization, and the like may be used.

The present invention is implemented by shaking, before drinking, the container filled with the above-described beverage containing at least the fermentation-derived cellulose. The shaking method is not particularly limited, and for example, a method of holding and shaking up and down the container for a period of 10 seconds to 1 minute may be used. As a result, the potable liquid, preferably the beverage, has fine delicate foam created not only on the surface of the beverage but also within the beverage, the foam having an excellent shape retention property.

### (II) Foaming Beverage

Characteristically, a foaming beverage according to the present invention contains a fermentation-derived cellulose in a state of a complex with the high molecular substance. The feature of the beverage is that since the beverage is obtained by compounding the fermentation-derived cellulose and the high molecular substance, when a container containing the beverage is shaken so as to create foam, the foam created within the beverage as well as in the top layer of the beverage can be retained stably.

The type of the high molecular substance to be complexed with the fermentation-derived cellulose and the contents of the fermentation-derived cellulose and high molecular substance are as described in (I). The foaming beverage according to the present invention may further contain an emulsifier. The type and the content of the emulsifier are also described above. The foaming beverage according to the present invention may further contain a polysaccharide, and the type and content of the polysaccharide are also described above. The foaming beverage which is targeted by the present invention includes the beverage containing milk components, the fruit beverage, and the vegetable beverage as described above.

The foaming beverage according to the present invention has the above-described features (foaming property and stable foam retention property), and thus by shaking the container filled with the beverage before drinking, fine delicate foam is created not only in the top layer of the beverage and also within the beverage, the foam having an excellent shape retention property. The shaking method is not particularly limited, and for example, a method of holding and shaking up and down the container for a period of 10 seconds to 1 minute may be used.

### Example

Hereinafter, the present invention will be specifically described with reference to examples and comparative examples below. However, the present invention will not be limited thereto. Further, unless otherwise specified, “parts” indicates “weight parts”, and “%” indicates “weight (wt.) %”.

“San Artist (trademark registered in Japan) PG” (produced by San-Ei Gen F. F. I., Inc.) used in the examples is a powder preparation containing 20% of fermentation-derived cellulose, and 6.7% of guar gum, and 6.7% of CMC sodium salt, and 66.6% of dextrin. Further, “San Artist (trademark registered in Japan) PX” (produced by San-Ei Gen F. F. I., Inc.) is a powder preparation containing 20% of fermentation-derived cellulose, 10% of xanthan gum, 3.3% of CMC sodium salt, and 66.7% of dextrin.

### Example 1

### Canned Coffee-Milk Beverage

In accordance with a formulation shown in Table 1, various canned coffee-milk beverages were prepared.

### <Formulation>

| | | |
|---|---|---|
| 1. | Coffee extract (L-value 21, Brix 4.0) | 27.52 (%) |
| 2. | Sugar | 5.0 |
| 3. | Nonfat dry milk | 3.5 |
| 4. | 10% w/v baking soda solution adjusted to pH | 6.8 |
| 5. | Additive (Table 1) | see Table 1 |

| | |
|---|---|
| Total volume adjusted with water | 100.0 ml |

TABLE 1

| | | Additive |
|---|---|---|
| | Additive | amount (%) |
| Control example | None | — |
| Example 1 | San Artist PG | 0.3 |
| Comparative | Guar gum | 0.2 |
| example 1 | | |
| Comparative | CMC sodium salt | 0.25 |
| example 2 | | |
| Comparative | Xanthan gum | 0.1 |
| example 3 | | |
| Comparative | Microcrystalline | 0.2 |
| example 4 | cellulose | |
| | preparation⁽¹⁾ | |

⁽¹⁾Preparation containing 73% of a microcrystalline cellulose, 5% of CMC-Na, 2.8% of xanthan gum, 19% of dextrin, and 0.2% of edible oil and fat (a microcrystalline cellulose preparation used in the following examples also have the same compounding ratio)

### <Preparation Method>

1) Add sugar, nonfat dry milk, and various additives to water, and stir the mixture for 10 minutes at 80° C. so as to be dissolved. After being dissolved, cool the mixture to 10° C. or lower.
2) Add a coffee extract to the solution prepared as above, and adjust the pH of the mixture with baking soda solution to pH 6.8.
3) Homogenize the above prepared solution at 75° C. (first stage: 10 Mpa, and second stage: 5 Mpa).
4) Pour 130 g of the above-obtained solution into a 190 g-capacity can and seal.
5) Sterilize the solution by heating at 85° C. for 60 minutes.
6) Place the sterilized solution in a refrigerator to be cooled down to and stored at 10° C. or lower.

### <Experimental Method>

1) Pour 20 ml of each content of the various canned coffee-milk beverages prepared as above into a measuring cylinder of a 100 ml capacity, and shake the measuring cylinder vigorously by 20 times so that foam is created within each beverage. Measure the height of the created foam (height of the foam volume portion: cm) (foaming property).
2) Leave each of the above various foamed coffee-milk beverages at room temperature, and measure the height of the foam (height of foam volume portion: cm) over time (5 minutes, 10 minutes, 20 minutes, 30 minutes) (evaluation of foam retention property).
3) After leaving each beverage at the room temperature for 30 minutes, visually observe the foam within the beverage, and also observe mobility of the foam by pouring the beverage from the measuring cylinder into a glass. In addition, drink the beverage and evaluate the mouthfeel.

Results are shown in Table 2 and Table 3.

TABLE 2

| | | | Foam retention property (cm) | | | |
|---|---|---|---|---|---|---|
| | | Foaming | After | After | After | After |
| | Additive | property (cm) | 5 mins. | 10 mins. | 20 mins. | 30 mins. |
| Control | None | 40 | 35 | 33 | 30 | 21 |
| example | | | | | | |
| Example 1 | San Artist PG | 40 | 40 | 40 | 38 | 37 |
| Comparative | Guar gum | 32 | 31 | 30 | 27 | 23 |
| example 1 | | | | | | |
| Comparative | CMC sodium salt | 34 | 33 | 32 | 30 | 27 |
| example 2 | | | | | | |
| Comparative | Xanthan gum | 32 | 32 | 32 | 32 | 31 |
| example 3 | | | | | | |
| Comparative | Microcrystalline | 33 | 32 | 31 | 28 | 20 |
| example 4 | cellulose | | | | | |
| | preparation | | | | | |

TABLE 3

| | | Foam state | Foam mobility | |
|---|---|---|---|---|
| | Additive | in beverage | into glass | Mouthfeel |
| Control | None | Foam floated | Unable to | No mouthfeel |
| example | | quickly | move into | of foam |
| | | | glass but | |
| | | | remained | |
| Example 1 | San Artist | Fine delicate | Poured into | Mouthfeel of |
| | PG | foam remained | glass together | good texture |
| | | clearly | with beverage | foam |
| Comparative | Guar gum | Coarse foam | Unable to | Sticky, no |
| example 1 | | and quickly | move into | mouthfeel |
| | | vanished | glass but | of foam |
| | | | remained | |
| Comparative | CMC sodium | Coarse foam | Unable to | Sticky, no |
| example 2 | salt | and quickly | move into | mouthfeel of |
| | | vanished | glass but | foam |
| | | | remained | |
| Comparative | Xanthan | Coarse foam | Unable to | Coarse texture |
| example 3 | gum | and quickly | move into | (due to |
| | | vanished | glass but | complete |
| | | | remained | separation |
| | | | | after heat |
| | | | | sterilization), |
| | | | | no mouthfeel |
| | | | | of foam |
| Comparative | Microcrystalline | Foam floated | Unable to | No mouthfeel |
| example 4 | cellulose | quickly | move into | of foam |
| | preparation | | glass but | |
| | | | remained | |

### <Result>

As shown in above Table 2, when the coffee-milk beverage was prepared by adding San Artist PG that contains a fermentation-derived cellulose, the foam retention property of the beverage was enhanced, and the foam was stably retained in the beverage. In addition, as shown in Table 3, according to visual observation of the beverage (after 30 minutes), fine delicate foam clearly remained in the beverage. In pouring the foam into a glass, the foam was able to be poured into the glass together with the beverage. Upon drinking, it was possible to have a mouthfeel of drinking the foam together with the beverage.

On the other hand, the beverage (Control Example) without any additive and the beverage (Comparative Examples 1 to 4) containing additives other than the fermentation-derived cellulose each had coarse foam, and the foam in the beverage vanished quickly. Thus, it was not possible to have a mouthfeel of the foam upon drinking. Further, the beverages of the comparative examples had a sticky texture or a coarse texture, which was an adverse effect caused by blending of additives.

### Examples 2 to 7

### Canned Coffee-Milk Beverage

According to the following formulation, various canned coffee-milk beverages (pH 6.8) were prepared. The preparation method was based on that of the canned coffee-milk beverage of Example 1. Further, in a manner similar to Example 1, the foaming property, foam retention property, foam state within, foam mobility, and mouthfeel of the obtained coffee-milk beverages were evaluated.

### <Formulation>

| | | |
|---|---|---|
| 1. | Coffee extract (L-value 21, Brix 4.0) | 27.52% |
| 2. | Sugar | 5.0 |
| 3. | Nonfat dry milk | 3.5 |
| 4. | 10% w/v baking soda solution adjusted to pH | 6.8 |
| 5. | Additive (Table 4) | see Table 4 |

| | |
|---|---|
| Total volume adjusted with water | 100.0 ml |

TABLE 4

| | | Additive |
|---|---|---|
| | Additive | amount (%) |
| Control | None | — |
| Example | | |
| Example 2 | San Artist PG | 0.2 |
| Example 3 | San Artist PG | 0.3 |
| Example 4 | San Artist PG | 0.4 |
| Example 5 | San Artist PG | 0.5 |
| Example 6 | San Artist PG | 0.6 |
| Example 7 | San Artist PG | 0.7 |

Results are shown in Table 5 and Table 6.

TABLE 5

| | | | Foam retention property (cm) | | | |
|---|---|---|---|---|---|---|
| | | Foaming | After | After | After | After |
| | Additive (wt. %) | property (cm) | 5 mins. | 10 mins. | 20 mins | 30 mins. |
| Control | None | 40 | 35 | 33 | 30 | 21 |
| example | | | | | | |
| Example 2 | San Artist PG 0.2% | 40 | 40 | 39 | 37 | 31 |
| Example 3 | San Artist PG 0.3% | 40 | 40 | 40 | 40 | 40 |
| Example 4 | San Artist PG 0.4% | 39 | 39 | 39 | 39 | 38 |
| Example 5 | San Artist PG 0.5% | 32 | 32 | 32 | 32 | 32 |
| Example 6 | San Artist PG 0.6% | 33 | 30 | 28 | 24 | 23 |
| Example 7 | San Artist PG 0.7% | 30 | 27 | 27 | 26 | 25 |

TABLE 6

| | Additive | Foam state in | Foam mobility | |
|---|---|---|---|---|
| | (Wt. %) | beverage | into glass | Mouthfeel |
| Control | None | Foam floated | Unable to | No mouthfeel |
| example | | quickly | move into | of foam |
| | | | glass but | |
| | | | remained | |
| Example 2 | San Artist | Fine delicate | Moved into | Mouthfeel |
| | PG 0.2% | foam remained | glass together | of foam |
| | | clearly | with beverage | |
| Example 3 | San Artist | Fine delicate | Moved into | Mouthfeel of |
| | PG 0.3% | foam remained | glass together | good texture |
| | | clearly | with beverage | foam |
| Example 4 | San Artist | Fine delicate | Moved into | Mouthfeel of |
| | PG 0.4% | foam remained | glass together | good texture |
| | | clearly | with beverage | foam |
| Example 5 | San Artist | Stable foam | Moved into | Slightly |
| | PG 0.5% | remained | glass together | sticky, but |
| | | clearly | with beverage | noticeable |
| | | | | mouthfeel of |
| | | | | drinking foam |
| Example 6 | San Artist | Stable foam | Moved into | Slightly |
| | PG 0.6% | remained | glass together | sticky, but |
| | | clearly | with beverage | noticeable |
| | | | | mouthfeel of |
| | | | | drinking foam |
| Example 7 | San Artist | Stable foam | Moved into | Slightly |
| | PG 0.7% | remained | glass together | sticky, but |
| | | clearly | with beverage | noticeable |
| | | | | mouthfeel of |
| | | | | drinking foam |

### <Result>

As shown in Table 5 and Table 6, when the coffee-milk beverages were prepared by adding San Artist PG that contains a fermentation-derived cellulose, the foam retention property of the beverages was enhanced, and the foam was stably retained in the beverages. When the ratio of the San Artist PG content was increased, the foam itself became stable, and when the beverage was poured into a glass, the foam was also poured together with the beverage (see Table 6). However, when the content was increased to 0.5% or more, the ratio of the foam volume tended to decrease (Table 5), and the mouthfeel tended to be sticky (Table 6). In this example (coffee-milk beverage), after overall consideration of the volume of the foam, the foam retention property, and the mouthfeel of the foam, the ratio of the San Artist PG content is preferably 0.2 to 0.5%, and more preferably 0.3 to 0.4%. By using this ratio of the San Artist PG content, it is possible to prepare a beverage having a well-balanced foaming property.

### Examples 8 to 10

### Canned Coffee-Milk Beverage

According to the following formulation, various canned coffee-milk beverages (pH 6.8) were prepared. The preparation method is based on that of the canned coffee-milk beverage of Example 1. Further, in a manner similar to Example 1, the foaming property, foam retention property, foam state within, foam mobility, and mouthfeel of the obtained coffee-milk beverages were evaluated.

### <Formulation>

| | | |
|---|---|---|
| 1. | Coffee extract (L-value 21, Brix 4.0) | 27.52% |
| 2. | Sugar | 5.0 |
| 3. | Nonfat dry milk | 3.5 |
| 4. | 10% w/v baking soda solution adjusted to pH | 6.8 |
| 5. | Additive agent (Table 7) | see Table 7 |
| 6. | Emulsifier (Table 7) | see Table 7 |

| | |
|---|---|
| Total volume adjusted with water | 100.0 ml |

TABLE 7

| | Additive (wt. %) | | Emulsifier (wt. %) | |
|---|---|---|---|---|
| Control | — | — | — | — |
| example | | | | |
| Example 8 | San Artist PG | 0.3 | — | — |
| Example 9 | San Artist PG | 0.3 | Sucrose fatty acid ester | 0.05 |
| | | | (HLB 16) | |
| Example | San Artist PG | 0.3 | Distilled monoglyceride | 0.05 |
| 10 | | | (HLB 3.8) | |

Results are shown in Table 8 and Table 9.

TABLE 8

| | Fermentation-derived | | Foam retention property (cm) | | | |
|---|---|---|---|---|---|---|
| | cellulose | Foaming | After | After | After | After |
| | Emulsifier | property (cm) | 5 mins. | 10 mins. | 20 mins | 30 mins. |
| Control | None | 40 | 35 | 33 | 30 | 21 |
| example | None | | | | | |
| Example 8 | San Artist PG | 34 | 34 | 34 | 34 | 34 |
| | None | | | | | |
| Example 9 | San Artist PG | 41 | 40 | 40 | 40 | 40 |
| | Sucrose fatty acid ester | | | | | |
| | (HLB 16) | | | | | |
| Example 10 | San Artist PG | 43 | 41 | 41 | 40 | 40 |
| | Distilled | | | | | |
| | monoglyceride (HLB 3.8) | | | | | |

TABLE 9

| | Fermentation-derived | | | |
|---|---|---|---|---|
| | cellulose | Foam state in | Foam mobility | |
| | Emulsifier | beverage | into glass | Mouthfeel |
| Control | None | Foam floated | Unable to | No mouthfeel |
| example | None | quickly | move into | of foam |
| | | | glass but | |
| | | | remained | |
| Example | San Artist PG | Fine delicate | Moved into | Mouthfeel of |
| 8 | No added | foam remained | glass together | good texture |
| | | clearly | with beverage | foam |
| Example | San Artist PG | Fine delicate | Moved into | Mouthfeel of |
| 9 | Sucrosefattyacidester | foam remained | glass together | good soft |
| | ( HLB 16) | clearly | with beverage | texture foam |
| Example | San Artist PG | Fine delicate | Moved into | Stable foam, |
| 10 | Distilled | foam remained | glass together | noticeable |
| | monoglyceride (HLB 3.8) | clearly | with beverage | mouthfeel of |
| | | | | foam |

### <Result>

As shown in above Table 8, when the coffee-milk beverages were prepared by adding, together with the emulsifier, San Artist PG that contains a fermentation-derived cellulose, the foam retention property of the beverages were further enhanced, and the foam was stably retained within the beverages. The foam retention property was not affected by the difference in HLB of the emulsifier. However, when the emulsifier having a high HLB value was used, a mouthfeel of fine soft foam was able to be obtained, whereas when the emulsifier having a low HLB value was used, stable foam was created and a beverage providing a mouthfeel of stable foam was able to be prepared. Accordingly, by appropriately adjusting the HLB of the emulsifier depending on the type and purpose of the beverage, it is possible to prepare a beverage providing a desired mouthfeel.

### Examples 11 to 12

### Bottled Milk Tea

According to the following formulation, various types of bottled milk tea (pH 6.5) were prepared.

### <Formulation>

| | | |
|---|---|---|
| 1. | Tea extract (Brix: 0.7 × 37.1%) | 0.26 (%) |
| 2. | Sugar | 6.5 |
| 3. | Nonfat dry milk | 3.5 |
| 4. | Trisodium citrate | 0.05 |
| 5. | Additive (Table 10) | see Table 10 |
| 6. | Emulsifier (Table 10) | see Table 10 |

| | |
|---|---|
| Total volume adjusted with water | 100.0 ml |

TABLE 10

| | Additive | | Emulsifier | |
|---|---|---|---|---|
| | (wt. %) | | (wt. %) | |
| Control | — | — | — | — |
| example | | | | |
| Comparative | — | — | Distilled monoglyceride | 0.05 |
| example 5 | | | (HLB 3.8) | |
| Example 11 | San Artist PG | 0.3 | — | — |
| Example 12 | San Artist PG | 0.3 | Distilled monoglyceride | 0.05 |
| | | | (HLB 3.8) | |

### <Preparation Method>

1) Add 100 g of Ceylon tea leaves to hot water, at 85° C., having an amount 53 times as much as the tea leaves (5300 g), so as to be immersed for extraction for four minutes. Filter the mixture with a filter paper, and cool the filtered solution (tea extract).
2) Add sugar, nonfat dry milk, trisodium citrate, and various additives to water, and stir and dissolve the mixture at 65 to 70° C. for 10 minutes.
3) Add the tea extract to the above solution, heat the mixture up to 70° C., and homogenize the mixture (first stage: 10 Mpa, and second stage: 5 Mpa).
4) Pour the above-obtained solution into a bottle and seal.
5) Sterilize the solution by heating at 85° C. for 60 minutes.
6) Place the sterilized solution in a refrigerator to be cooled down to and stored at 10° C. or lower.

### <Experimental Method>

1) Pour 80 ml of each content of the various bottled milk tea prepared as above into a 100 ml bottle with a lid. Take an 11 ml specimen from a central portion of each bottled milk tea using a pipette, and measure the weight (pre-foaming 11 ml weight). Thereafter, shake the bottle 30 times for foaming. Leave the shaken bottle for 15 minutes, and then shake again 30 times for foaming. Take another 11 ml specimen from the central portion of each milk tea using a pipette, and measure the weight (post-foaming 11 ml weight).
2) Obtain, from the pre-foaming 11 ml weight and the post-foaming 11 ml weight, the retention property of foam contained in each beverage as an “overrun rate (%)” by using the following formula.

Overrun (OR) rate (%)=[(pre-foaming 11 ml weight−post-foaming 11 ml weight)/post-foaming 11 ml weight]×100 [Formula 1]
3) Leave the various types of the bottled milk tea having the foam created as above at room temperature, so as to measure time elapsed until the foam completely vanishes and to visually observe appearance of the foam 24 hours after the foam creation (long-term foam retention).

Results are shown in Table 11.

TABLE 11

| | | Foam content | | | Long-term foam retention | |
|---|---|---|---|---|---|---|
| | | Pre-foam | Post-foam | OR | Foam | |
| | Additive | 11 ml | 11 ml | rate | vanishing | After |
| | Emulsifier | weight | weight | (%) | time | 24 hrs. |
| Control | None | 11.8 | 11.8 | 0 | 2 mins. | Foam |
| example | | | | | | vanished |
| | | | | | | completely |
| Comparative | None | 11.8 | 11.6 | 1.7 | 5 mins. | Foam |
| example 5 | Distilled | | | | | vanished |
| | monoglyceride | | | | | completely |
| | (HLB 3.8) | | | | | |
| Example 11 | San Artist PG | 11.8 | 9.8 | 20.4 | 60 mins or | Foam |
| | None | | | | more | vanished |
| | | | | | | completely |
| Example 12 | San Artist PG | 11.8 | 7.8 | 51.3 | 24 hrs. or | Fine foam |
| | Distilled | | | | more | remained |
| | monoglyceride | | | | | top layer |
| | (HLB 3.8) | | | | | |

### <Result>

As shown in Table 11, when the emulsifier is used together with San Artist PG that contains a fermentation-derived cellulose, it was possible to further enhance the foam retention property of San Artist PG. In addition, a large volume of foam was retained in the beverages. Further, by using the emulsifier together with the San Artist PG, it was also possible to retain a large volume of fine foam on the top of the beverage for a long period of time.

### Examples 13 to 20

### Canned Coffee-Milk Beverage

According to the following formulation, various canned coffee-milk beverages (pH 6.8) were prepared. The preparation method was based on that of the canned coffee-milk beverage of Example 1. Further, in a manner similar to Example 1, the foaming property, foam retention property, foam state within, foam mobility, and mouthfeel of the obtained coffee-milk beverages were evaluated.

### <Formulation>

| | | |
|---|---|---|
| 1. | Coffee extract (L-value 21, Brix 4.0) | 27.52% |
| 2. | Sugar | 5.0 |
| 3. | Nonfat dry milk | 3.5 |
| 4. | 10% w/v baking soda solution adjusted to pH | 6.8 |
| 5. | Additive (Table 12) | see Table 12 |
| 6. | Emulsifier (Table 12) | see Table 12 |
| 7. | Polysaccharide (Table 12) | see Table 12 |

| | |
|---|---|
| Total volume adjusted with water | 100.0 ml |

TABLE 12

| | Fermentation-derived | | | | | |
|---|---|---|---|---|---|---|
| | cellulose (wt. %) | | Emulsifier (wt. %) | | Polysaccharide (wt. %) | |
| Control | — | — | — | — | — | — |
| example | | | | | | |
| Example 13 | San Artist PG | 0.3 | Distilled monoglyceride | 0.05 | — | — |
| | | | (HLB3.8) | | | |
| Example 14 | San Artist PG | 0.3 | Distilled monoglyceride | 0.05 | λ-carageenan | 0.2 |
| | | | (HLB 3.8) | | | |
| Example 15 | San Artist PG | 0.3 | Distilled monoglyceride | 0.05 | Agar | 0.1 |
| | | | (HLB 3.8) | | | |
| Example 16 | San Artist PG | 0.3 | Distilled monoglyceride | 0.05 | Xanthan gum | 0.1 |
| | | | (HLB 3.8) | | | |
| Example 17 | San Artist PG | 0.3 | Distilled monoglyceride | 0.05 | Native gellan | 0.02 |
| | | | (HLB 3.8) | | gum | |
| Example 18 | San Artist PG | 0.3 | Distilled monoglyceride | 0.05 | Tamarind seed | 0.2 |
| | | | (HLB 3.8) | | gum | |
| Example 19 | San Artist PG | 0.3 | Distilled monoglyceride | 0.05 | Microcrystalline | 0.2 |
| | | | (HLB 3.8) | | cellulose | |
| | | | | | preparation | |
| Example 20 | San Artist PG | 0.3 | Distilled monoglyceride | 0.05 | CMC sodium | 0.25 |
| | | | (HLB 3.8) | | salt | |

Results are shown in Table 13 and Table 14.

TABLE 13

| | Fermentation-derived | | | | | |
|---|---|---|---|---|---|---|
| | cellulose | | Foam retention (cm) | | | |
| | Emulsifier | Foaming | After | After | After | After |
| | Polysaccharide | property (cm) | 5 mins. | 10 mins. | 20 mins. | 30 mins. |
| Control | None | 40 | 35 | 33 | 30 | 21 |
| example | | | | | | |
| Example 13 | San Artist PG | 43 | 43 | 43 | 43 | 43 |
| | Distilled monoglyceride | | | | | |
| | (HLB 3.8) | | | | | |
| | None | | | | | |
| Example 14 | San Artist PG | 38 | 38 | 38 | 38 | 38 |
| | Distilled monoglyceride | | | | | |
| | (HLB 3.8) | | | | | |
| | λ-carageenan | | | | | |
| Example 15 | San Artist PG | 35 | 35 | 35 | 35 | 35 |
| | Distilled monoglyceride | | | | | |
| | (HLB 3.8) | | | | | |
| | Agar | | | | | |
| Example 16 | San Artist PG | 32 | 32 | 32 | 32 | 32 |
| | Distilled monoglyceride | | | | | |
| | (HLB 3.8) | | | | | |
| | Xanthan gum | | | | | |
| Example 17 | San Artist PG | 40 | 40 | 40 | 40 | 40 |
| | Distilled monoglyceride | | | | | |
| | (HLB 3.8) | | | | | |
| | Native gellan gum | | | | | |
| Example 18 | San Artist PG | 32 | 31 | 31 | 31 | 31 |
| | Distilled monoglyceride | | | | | |
| | (HLB 3.8) | | | | | |
| | Tamarind seed gum | | | | | |
| Example 19 | San Artist PG | 42 | 42 | 41 | 40 | 40 |
| | Distilled monoglyceride | | | | | |
| | (HLB 3.8) | | | | | |
| | Microcrystalline | | | | | |
| | cellulose preparation | | | | | |
| Example 20 | San Artist PG 32 | 32 | 31 | 31 | 30 | 30 |
| | Distilled monoglyceride | | | | | |
| | (HLB 3.8) | | | | | |
| | CMC sodium salt | | | | | |

TABLE 14

| | Fermentation-derived | | | |
|---|---|---|---|---|
| | cellulose | | | |
| | Emulsifier | Foam state in | Foam mobility | |
| | Polysaccharide | beverage | into glass | Mouthfeel |
| Control | None | Foam floated | Unable to | No mouthfeel |
| Example | | quickly | move into | of foam |
| | | | glass but | |
| | | | remained | |
| Example 13 | San Artist PG | Fine delicate | Moved into | Mouthfeel |
| | Distilled | foam remained | glass together | of foam |
| | monoglyceride | clearly | with beverage | |
| | (HLB 3.8) | | | |
| | None | | | |
| Example 14 | San Artist PG | Fine delicate | Moved into | Slightly |
| | Distilled | foam remained | glass together | sticky, but |
| | monoglyceride | clearly | with beverage | mouthfeel of |
| | (HLB 3.8) | | | foam |
| | λ-carageenan | | | |
| Example 15 | San Artist PG | Fine delicate | Moved into | Mouthfeel of |
| | Distilled | foam remained | glass together | soft foam |
| | monoglyceride | clearly | with beverage | |
| | (HLB 3.8) | | | |
| | Agar | | | |
| Example 16 | San Artist PG | Large foam | Moved into | Mouthfeel of |
| | Distilled | remained | glass together | stable foam |
| | monoglyceride | clearly | with beverage | |
| | (HLB 3.8) | | | |
| | xanthan gum | | | |
| Example 17 | San Artist PG | Fine delicate | Moved into | Slightly |
| | Distilled | foam remained | glass together | sticky, but |
| | monoglyceride | clearly | with beverage | mouthfeel of |
| | (HLB 3.8) | | | foam |
| | Native gellan gum | | | |
| Example 18 | San Artist PG | Fine delicate | Moved into | Mouthfeel of |
| | Distilled | foam remained | glass together | good texture |
| | monoglyceride | clearly | with beverage | foam |
| | (HLB 3.8) | | | |
| | Tamarind seed gum | | | |
| Example 19 | San Artist PG | Fine delicate | Moved into | Mouthfeel of |
| | Distilled | foam remained | glass together | good texture |
| | monoglyceride | clearly | with beverage | foam |
| | (HLB 3.8) | | | |
| | Microcrystalline | | | |
| | cellulose preparation | | | |
| Example 20 | San Artist PG | Fine delicate | Moved into | Slightly |
| | Distilled | foam remained | glass together | sticky, but |
| | monoglyceride | clearly | with beverage | mouthfeel of |
| | (HLB 3.8) | | | foam |
| | CMC sodium salt | | | |

### <Result>

As shown in Table 14, when the coffee-milk beverages were prepared by adding polysaccharide together with the emulsifier and San Artist PG that contains a fermentation-derived cellulose, it was possible to provide various mouthfeels to the beverage while maintaining the beverage foam retention property enhanced by San Artist PG and the emulsifier. Accordingly, by changing the types of polysaccharide depending on the type and purpose of the beverage to be targeted, it is possible to add a desired mouthfeel to the beverage.

### Examples 21 to 23

### Bottled Milk Tea

According to the following formulation, various bottled milk tea beverages (pH 6.5) were prepared. The preparation method was based on that of the bottled milk tea of Example 11. Further, in a manner similar to Example 1, the foaming property, foam retention property, foam state within, foam mobility, and mouthfeel of the obtained milk tea were evaluated.

### <Formulation>

| | | |
|---|---|---|
| 1. | Tea extract (Brix: 0.7 × 37.1%) | 0.26% |
| 2. | Sugar | 6.5 |
| 3. | Nonfat dry milk | 3.5 |
| 4. | Trisodium citrate | 0.05 |
| 5. | Additive (Table 15) | see Table 15 |
| 6. | Emulsifier (Table 15) | see Table 15 |
| 7. | Polysaccharide (Table 15) | see Table 15 |

| | |
|---|---|
| Total volume adjusted with water | 100.0 ml |

TABLE 15

| | Additive (wt. %) | | Emulsifier (wt. %) | | Polysaccharide (wt. %) | |
|---|---|---|---|---|---|---|
| Control | None | — | None | — | None | — |
| example | | | | | | |
| Example 21 | San | 0.3 | Distilled | 0.05 | None | — |
| | Artist | | monoglyceride | | | |
| | PG | | (HLB 3.8) | | | |
| Example 22 | San | 0.3 | Distilled | 0.05 | Microcrystalline | 0.2 |
| | Artist | | monoglyceride | | cellulose | |
| | PG | | (HLB 3.8) | | preparation | |
| Example 23 | San | 0.3 | Sucrose fatty | 0.03 | Microcrystalline | 0.2 |
| | Artist | | acid ester | | cellulose | |
| | PG | | (HLB 16) | | preparation | |

Results are shown in Table 16 and Table 17.

TABLE 16

| | Fermentation-derived | | | | | |
|---|---|---|---|---|---|---|
| | cellulose | | Foam retention property (cm) | | | |
| | Emulsifier | Foaming | After | After | After | After |
| | Polysaccharide | property (cm) | 5 mins. | 10 mins. | 20 mins. | 30 mins. |
| Control | None | 30 | 20 | 20 | 20 | 20 |
| example | | | | | | |
| Example 21 | San Artist PG | 40 | 40 | 38 | 36 | 36 |
| | Distilled monoglyceride | | | | | |
| | (HLB 3.8) | | | | | |
| | None | | | | | |
| Example 22 | San Artist PG | 35 | 33 | 32 | 32 | 31 |
| | Distilled monoglyceride | | | | | |
| | (HLB 3.8) | | | | | |
| | Microcrystalline | | | | | |
| | cellulose preparation | | | | | |
| Example 23 | San Artist PG | 36 | 36 | 36 | 35 | 35 |
| | Sucrose fatty acid ester | | | | | |
| | (HLB 16) | | | | | |
| | Microcrystalline | | | | | |
| | cellulose preparation | | | | | |

TABLE 17

| | Fermentation-derived | | | |
|---|---|---|---|---|
| | cellulose | | | |
| | Emulsifier | Foam state in | Foam mobility | |
| | Polysaccharide | beverage | into glass | Mouthfeel |
| Control | None | Foam floated | Unable to | No mouthfeel |
| example | | quickly | move into | of foam |
| | | | glass but | |
| | | | remained | |
| Example 21 | San Artist PG | Fine delicate | Moved into | Mouthfeel |
| | Distilled | foam remained | glass together | of foam |
| | monoglyceride | clearly | with beverage | |
| | (HLB 3.8) | | | |
| | None | | | |
| Example 22 | San Artist PG | Fine delicate | Moved into | Stable foam, |
| | Distilled | foam remained | glass together | and mouthfeel |
| | monoglyceride | clearly | with beverage | of most remarkable |
| | (HLB 3.8) | | | foam |
| | Microcrystalline | | | |
| | cellulose | | | |
| | preparation | | | |
| Example 23 | San Artist PG | Most fine | Moved into | Mouthfeel of |
| | Sucrose fatty acid | delicate foam | glass together | good soft |
| | ester | remained | with beverage | texture foam |
| | (HLB 16) | clearly | | |
| | Microcrystalline | | | |
| | cellulose | | | |
| | preparation | | | |

### <Result>

As shown in above tables, when the milk tea was prepared by adding the emulsifier solely or both the microcrystalline cellulose and the emulsifier to San Artist PG that contains a fermentation-derived cellulose, the foam retention property of the beverage was further enhanced, and the foam was stably retained in the beverage. Further, by adding the microcrystalline cellulose together with San Artist PG and the emulsifier, it was possible to create further fine delicate foam. In this case, when the emulsifier having a high HLB value was used, a mouthfeel of fine soft foam was provided, whereas when the emulsifier having a low HLB value was used, stable foam was created and a beverage providing a mouthfeel of stable foam was prepared. Accordingly, by changing the HLB of the emulsifier depending on the type and purpose of the beverage, it is possible to add a desired mouthfeel to the beverage.

### Example 24

### PET-Bottled Acidic Milk Beverage

In accordance with the following formulation, various PET-bottled acidic milk beverages (pH 3.7) were prepared.

### <Formulation>

| | | |
|---|---|---|
| 1. | Pineapple juice | 0.66 (%) |
| | (5 times concentrated, clear) | |
| 2. | Sugar | 6.0 |
| 3. | Nonfat dry milk | 3.0 |
| 4. | 50% w/v citric acid adjusted to pH | 3.7 |
| 5. | Colorant⁽¹⁾ | 0.02 |
| 6. | Flavor⁽²⁾ | 0.1 |
| 7. | Stabilizer for acidic milk beverage⁽³⁾ | 0.3 |
| 8. | Additive | see Table 18 |

| | |
|---|---|
| Total volume adjusted with water | 100.0% |

⁽¹⁾San Yellow NO. 2SFU: produced by San-Ei Gen F. F. I., Inc.
⁽²⁾Pineapple flavor No. 93614: produced by San-Ei Gen F. F. I., Inc.
⁽³⁾Soybean polysaccharide SM-1200: produced by San-Ei Gen F. F. I., Inc.

TABLE 18

| | | Additive |
|---|---|---|
| | | amount |
| | Additive | (%) |
| Control | None | — |
| example | | |
| Example 24 | San Artist PG | 0.5 |
| Comparative | Guar gum | 0.3 |
| example 6 | | |
| Comparative | CMC Na salt (CMC-Na) | 0.4 |
| example 7 | | |
| Comparative | Agar | 0.1 |
| example 8 | | |
| Comparative | Microcrystalline | 0.4 |
| example 9 | cellulose preparation | |
| Comparative | High-methoxyl pectine | 0.4 |
| example 10 | | |

### <Preparation Method>

1) Add sugar, nonfat dry milk, a stabilizer for an acid milk beverage, and various additives to water, and stir and dissolve the mixture at 80° C. for 10 minutes.
2) Add concentrated fruit juice to the solution prepared as above, and adjust the pH of the mixture with a citric acid solution to pH 3.7.
3) Homogenize the above-prepared solution at 75° C. (pressure: first stage: 10 Mpa, and second stage: 5 Mpa).
4) Sterilize the solution at 95° C., pour the hot solution into a PET bottle, and cool the PET-bottle down to 7° C. or lower.

### <Experimental Method>

1) Visually observe stability of the various PET-bottled acidic milk beverages, which were prepared based on the above method, after sterilization at 95° C. Next, pour 80 ml of each of the various beverages prepared as above into a 100 ml bottle with a lid. First, take an 11 ml specimen from a central portion of each beverage using a pipette, and measure the weight (pre-foaming 11 ml weight). Thereafter, shake the bottle 30 times for foaming. Leave the shaken bottle for 15 minutes, and then shake the bottle again 30 times for foaming. Take another 11 ml specimen from the central portion using a pipette, and measure the weight (post-foaming 11 ml weight).
2) Obtain, from the pre-foaming 11 ml weight and the post-foaming 11 ml weight, the retention property of the foam contained in the beverage as the “overrun rate (%)” in accordance with the following formula.

Overrun (OR) rate (%)=[(pre-foaming 11 ml weight−post-foaming 11 ml weight)/post-foaming 11 ml weight]×100 [Formula 2]
3) After creation of the foam, leave each beverage at room temperature for 30 minutes, and then visually observe the foam within the beverage. Also, Pour the beverage from the bottle into a glass so as to observe mobility of the foam. In addition, drink each beverage so as to evaluate the mouthfeel.

Results are shown in Table 19 and Table 20.

TABLE 19

| | | | Foam content | | |
|---|---|---|---|---|---|
| | | Stability | Pre-foaming | Post-foaming | OR |
| | | after | 11 ml weight | 11 ml weight | rate |
| | Additive | sterilization | (g) | (g) | (%) |
| Control | None | Stable | 11.9 | 11.7 | 1.7 |
| example | | | | | |
| Example 24 | San Artist PG | Stable | 11.9 | 9.8 | 21.4 |
| Comparative | Guar gum | Aggregated | 11.9 | 11.5 | 3.5 |
| example 6 | | and separated | | | |
| Comparative | CMC-Na | Slightly | 11.9 | 11.6 | 2.6 |
| example 7 | | precipitated | | | |
| Comparative | Agar | Stable | 11.9 | 11.4 | 4.4 |
| example 8 | | | | | |
| Comparative | Microcrystalline | Slightly | 11.9 | 11.5 | 3.5 |
| example 9 | cellulose | precipitated | | | |
| | preparation | | | | |
| Comparative | High-methoxyl | Slightly | 11.9 | 11.8 | 0.9 |
| example 10 | pectine | precipitated | | | |

TABLE 20

| | | Foam state in | Foam mobility | |
|---|---|---|---|---|
| | Additive | beverage | into glass | Mouthfeel |
| Control | None | Foam floated | Unable to | No mouthfeel |
| example | | quickly | move into | of foam |
| | | | glass but | |
| | | | remained | |
| Example 24 | San Artist PG | Fine delicate | Moved into | Mouthfeel of |
| | | foam remained | glass together | good texture |
| | | clearly | with beverage | foam |
| Comparative | Guar gum | Coarse foam | Unable to | Sticky, and no |
| example 6 | | and quickly | move into | mouthfeel of |
| | | vanished | glass but | foam |
| | | | remained | |
| Comparative | CMC-Na | Coarse foam | Unable to | No mouthfeel |
| example 7 | | and quickly | move into | of foam |
| | | vanished | glass but | |
| | | | remained | |
| Comparative | Agar | Coarse foam | Unable to | No mouthfeel |
| example 8 | | and quickly | move into | of foam |
| | | vanished | glass but | |
| | | | remained | |
| Comparative | Microcrystalline | Coarse foam | Unable to | No mouthfeel |
| example 9 | cellulose | and quickly | move into | of foam |
| | preparation | vanished | glass but | |
| | | | remained | |
| Comparative | High-methoxyl | Coarse foam | Unable to | No mouthfeel |
| example 10 | pectine | and quickly | move into | of foam |
| | | vanished | glass but | |
| | | | remained | |

### <Result>

As shown in Table 19, when the acidic milk beverage was prepared by adding San Artist PG that contains the fermentation-derived cellulose complex, the foam retention property of the beverage was enhanced, and the foam was stably retained in the beverage. Further, for equal to or more than 120 minutes after the foam was created, the foam was retained in the top layer of and within the beverage. In addition, as shown in Table 20, according to visual observation of the beverage (after 30minutes), fine delicate foam clearly remained in the beverage. In pouring the foam into a glass, the foam was possible to be poured into the glass together with the beverage. Upon drinking, it had a mouthfeel of drinking the foam together with the beverage. On the other hand, the beverage without any additive (control example) and the beverages containing other additives (comparative examples 6 to 10) each had coarse foam, and the foam in the beverage vanished quickly. Thus, there was no mouthfeel of foam upon drinking.

### Examples 25 to 29

### Bottled Matcha Milk Beverage

In accordance with a formulation shown in Table 21, various bottled Matcha milk beverages were prepared.

### <Formulation>

| | | |
|---|---|---|
| 1. | Matcha powder | 0.5 (%) |
| 2. | Sugar | 6.5 |
| 3. | Nonfat dry milk | 2.5 |
| 4. | Colorant⁽¹⁾ | 0.03 |
| 5. | Antioxidant(2) | 0.1 |
| 6. | Flavor⁽³⁾ | 0.17 |
| 7. | Emulsifier⁽⁴⁾ | 0.03 |
| 8. | Additive (Table 21) | see Table 21 |
| 9. | Polysaccharide (Table 21) | see Table 21 |
| 10. | Salt (Table 21) | see Table 21 |

| | |
|---|---|
| Total volume adjusted with water | 100.0 ml |

⁽¹⁾Melon color L: produced by San-Ei Gen F. F. I., Inc.
⁽²⁾San Melin (trademark registered in U.S.) Y-AF: produced by San-Ei Gen F. F. I., Inc.
⁽³⁾Matcha enhancer NO. 69920:Matcha flavor NO. 67003 (0.05:0.12) produced by San-Ei Gen F. F. I., Inc.
⁽⁴⁾Sucrose fatty acid ester (HLB 16)

TABLE 21

| | Fermentation-derived | | | | | |
|---|---|---|---|---|---|---|
| | cellulose (wt. %) | | Polysaccharide (wt. %) | | Salt (wt. %) | |
| Control | — | — | — | — | — | — |
| example | | | | | | |
| Example 25 | San Artist PG | 0.3 | — | — | Sodium | 0.1 |
| | | | | | polyphosphate | |
| Example 26 | San Artist PG | 0.3 | — | — | Tripotassium | 0.1 |
| | | | | | phosphate | |
| Example 27 | San Artist PG | 0.3 | — | — | Dipotassium | 0.1 |
| | | | | | hydrogen phosphate | |
| Example 28 | San Artist PG | 0.3 | — | — | Trisodium citrate | 0.1 |
| Example 29 | San Artist PG | 0.3 | CMC sodium | 0.05 | Trisodium citrate | 0.1 |
| | | | salt | | | |

### <Preparation Method>

1) Add sugar, nonfat dry milk, a Matcha powder and various additives to water, and stir and dissolve the mixture at 65 to 70° C. for 10 minutes. Homogenize the mixture at 70° C. (first stage: 10 Mpa, and second stage: 5 Mpa).
2) Pour 130 g of the above-obtained solution into a 190 g-capacity clear bottle and seal.
3) Sterilize the bottle by heating at 85° C. for 60 minutes.
4) Place the sterilized bottled solution in a refrigerator to be cooled down to and stored at 10° C. or lower.

### <Experimental Method>

1) Open lids of the various bottled Matcha milk beverages prepared as above, so as to expose the beverages to the external air, and then close the bottles with lids. Shake each bottle 20 times vigorously for foaming. Observe the state of the foam immediately after the foam creation (foaming property).
2) Leave each of the various bottled Matcha milk beverages having the foam created as above at room temperature for 30 minutes, and then visually observe dispersion stability of the Matcha powder within the beverage solution, stability of the milk components, the state of the foam on the surface of the beverage (foam retention property), and the foam (foam content) contained in the beverage. In addition, drink the beverage and evaluate the mouthfeel.

Results are shown in Table 22 and Table 23.

“B” in respective items in the following table indicates that the beverage satisfies basic desired effects of the present invention if the beverage is marketed. “A” indicates that the beverage satisfies desired effects of the present invention sufficiently or more. “C” indicates that the beverage has no commercial value from an objective viewpoint.

TABLE 22

| | Dispersion stability of Matcha powder | | Stability of milk components | |
|---|---|---|---|---|
| Control | C | Precipitated | C | Aggregated and |
| example | | | | separated |
| Example 25 | B | Slightly precipitated but | B | Preferable |
| | | preferable | | |
| Example 26 | B | Slightly precipitated but | B | Preferable |
| | | preferable | | |
| Example 27 | B | Slightly precipitated but | B | Preferable |
| | | preferable | | |
| Example 28 | B | Slightly precipitated but | B | Preferable |
| | | preferable | | |
| Example 29 | A | very preferable | A | Very preferable |

TABLE 23

| | Foaming and foam | | Foam content | | | |
|---|---|---|---|---|---|---|
| | retention properties | | in beverage | | Beverage mouthfeel | |
| Control | C | Having foaming | C | Foam floated | C | No mouthfeel of |
| example | | property, but no | | quickly | | foam |
| | | foam retention | | | | |
| Example 25 | A | Excellent foaming | B | Foam remained | B | Mouthfeel of |
| | | and foam retention | | clearly | | foam, and good |
| | | properties | | | | beverage flavor |
| Example 26 | A | Excellent foaming | B | Foam remained | B | Mouthfeel of |
| | | and foam retention | | clearly | | foam, and good |
| | | properties | | | | beverage flavor |
| Example 27 | A | Excellent foaming | B | Foam remained | B | Mouthfeel of |
| | | and foam retention | | clearly | | foam, and good |
| | | properties | | | | beverage flavor |
| Example 28 | A | Excellent foaming | B | Foam remained | B | Mouthfeel of |
| | | and foam retention | | clearly | | foam, and good |
| | | property | | | | beverage flavor |
| Example 29 | A | Excellent foaming | A | Fine delicate | A | Mouthfeel of |
| | | and foam retention | | foam remained | | good texture |
| | | properties | | clearly | | foam, and good |
| | | | | | | flavor |

### <Result>

As shown in above Table 22 and Table 23, when each Matcha beverage containing the milk components was prepared by adding San Artist PG that contains the fermentation-derived cellulose complex, the ability to maintain dispersion of the Matcha powder was obtained, and thus it was possible to maintain the beverage stably even if the milk components were added. Accordingly, it was possible to prepare the Matcha beverage containing the milk components which excels in the foaming property and foam retention property, and which is capable of stably retaining the foam within the beverage. Further, according to Table 22 and Table 23, even if salts which are often used for beverages and food products were added, stability of the milk components in the Matcha beverage, dispersibility of the Matcha powder, and the foaming property were not affected thereby. Further, as for the beverages having the foam stably retained within the beverages (the “foam content” item being marked with “B” or “A”), when each beverage was poured into a glass, the foam was also poured into the glass together with the beverage.

Further, according to the above results, when a slight amount of a CMC sodium salt (0.05%) was added, the dispersion stability of the Matcha powder, the stability of the milk components, the foaming property, and the foam content are respectively improved, and a beverage of excellent quality was provided.

### Example 30

### Acidic Milk Beverage

According to the following formulation, acidic milk beverages (pH 3.8) were prepared.

TABLE 24
<Formulation>

| | | Comparative ex. | Example |
|---|---|---|---|
| 1. | Fructose glucose syrup | 6 | 6 |
| 2. | Non fat dry milk | 2 | 2 |
| 3. | Sucralose | 0.007 | 0.007 |
| 4. | Pineapple juice | 0.66 | 0.66 |
| | (5 times concentrated, unclear) | | |
| 5. | Citric acid (anhydrous) | 0.4 | 0.4 |
| 6. | Acidic milk stabilizer⁽¹⁾ | 0.2 | 0.2 |
| 7. | Acidic milk stabilizer⁽²⁾ | 0.1 | 0.1 |
| 8. | San Artist PG | — | 0.7 |
| 9. | Antioxidant⁽³⁾ | 0.05 | 0.05 |
| 10. | Colorant⁽⁴⁾ | 0.02 | 0.02 |
| 11. | Flavor⁽⁵⁾ | 0.15 | 0.15 |

| | | |
|---|---|---|
| Total volume adjusted with water | 100 | 100 |

⁽¹⁾SM-660 (soybean polysaccharide): produced by San-Ei Gen F. F. I., Inc.
⁽²⁾SM-1200 (soybean polysaccharide): produced by San-Ei Gen F. F. I., Inc.
⁽³⁾San Melin AO-1007: produced by San-Ei Gen F. F. I., Inc.
⁽⁴⁾San Yellow NO. 2SFU: produced by San-Ei Gen F. F. I., Inc.
⁽⁵⁾Pineapple flavor NO. 93614: produced by San-Ei Gen F. F. I., Inc.

### <Preparation Method>

(1) Add water to above constituent 1, and then add powder mixture of constituents 2, 3, and 6 to 8. Heat and stir the mixture at 80° C. for 10 minutes, and then cool the mixture to 20° C. or lower.
(2) Add constituents 4 and 5 to a solution prepared in (1), heat the mixture up to 80° C., and homogenize the mixture under the pressure of 10 MPa in the first stage, and under 5 MPa in the second stage.
(3) After sterilization at 93° C., add constituents 9 to 11, and conduct hot packing.

### <Experimental Method>

Pour the various acidic milk beverages (examples and comparative examples) prepared as above each into a 100 ml measuring cylinder, and stir each by vigorously shaking 20 times for foaming. Leave each beverage at room temperature for 30 minutes, and then visually observe the foam in the beverage. In addition, pour each beverage from the measuring cylinder to a glass to observe the state of the foam moving. Further, drink the beverage and evaluate the mouthfeel.

Results are shown in Table 25.

TABLE 25

| | Foam state in | Foam mobility | |
|---|---|---|---|
| Evaluation | beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

### Example 31

### Acidic Milk Beverage

According to the following formulation, acidic milk beverages (pH 3.8) were prepared.

TABLE 26
<Formulation>

| | | Comparative ex. | Example |
|---|---|---|---|
| 1. | Nonfat dry milk | 1.5 | 1.5 |
| 2. | Sugar | 7.0 | 7.0 |
| 3. | Sucralose | 0.002 | 0.002 |
| 4. | Apple juice | 1.65 | 1.65 |
| | (4 times concentrated, unclear) | | |
| 5. | Mixed citrus juice (unclear) | 1.1 | 1.1 |
| 6. | Passion fruit juice | 0.67 | 0.67 |
| | (unclear) NO. 16672 | | |
| 7. | Pineapple juice | 0.66 | 0.66 |
| | (5 times concentrated, unclear) | | |
| 8. | Acidic milk stabilizer⁽¹⁾ | 0.3 | 0.3 |
| 9. | Polysaccharide⁽²⁾ | 0.3 | 0.3 |
| 10. | San Artist PG | — | 0.5 |
| 11. | Emulsifier⁽³⁾ | — | 0.05 |
| 12. | Citric acid (anhydrous) | 0.13 | 0.13 |
| 13. | Trisodium citrate | 0.02 | 0.02 |
| 14. | Antioxidant⁽⁴⁾ | 0.05 | 0.05 |
| 15. | Flavor⁽⁵⁾ | 0.15 | 0.15 |

| | | |
|---|---|---|
| Total volume adjusted with with water | 100 | 100 |

⁽¹⁾SM-1200 (soybean polysaccharide): produced by San-Ei Gen F. F. I., Inc.
⁽²⁾SM-666 (pectine): produced by San-Ei Gen F. F. I., Inc.
⁽³⁾quillaja extract
⁽⁴⁾San Melin Y-AF: produced by San-Ei Gen F. F. I., Inc.
⁽⁵⁾Mix fruit flavor NO. 99111: produced by San-Ei Gen F. F. I., Inc.
<Preparation method >
⁽¹⁾Add above constituents 1 to 3 and 8 to 10 to water, and heat and stir the mixture at 80° C. for 10 minutes. Then cool the mixture to 20° C. or lower.
⁽²⁾Add constituents 4 to 7, and 11 to 13 to the solution prepared in ⁽¹⁾, and add water to the mixture.
⁽³⁾Heat the mixture up to 75° C., and then homogenize the mixture (under the pressure of 9,800 kPa (100 kgf/cm²) in the first stage, and under 4,900 kPa (100 kgf/cm²) in the second stage) by using a homogenizer.
⁽⁴⁾Heat the mixture up to 93° C., add constituents 14 and 15 to the mixture, so as to be hot packed.

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 27.

TABLE 27

| | Foam state in | Foam mobility | |
|---|---|---|---|
| Evaluation | beverage | into glass | Mouthfeel |
| Example | Foam floated | Unable to | No mouthfeel |
| | quickly | move into | of foam |
| | | glass but | |
| | | remained | |
| Comparative | Fine delicate | Moved into | Mouthfeel of |
| example | foam remained | glass together | good texture |
| | clearly | with beverage | foam |

### Example 32

### Cocoa Beverage

According to the following formulation, cocoa beverages (pH 6.3) were prepared.

TABLE 28
<Formulation>

| | | Comparative ex. | Example |
|---|---|---|---|
| 1. | Cocoa (F23) | 1 | 1 |
| 2. | Milk | 10 | 10 |
| 3. | Nonfat dry milk | 3 | 3 |
| 4. | Granulated sugar | 5 | 5 |
| 5. | Emulsifier⁽¹⁾ | 0.06 | — |
| 6. | Homogen No. 7331P | — | 0.86 |
| 7. | Flavor⁽²⁾ | 0.1 | 0.1 |

| | | |
|---|---|---|
| Total volume adjusted with water | 100 | 100 |

⁽¹⁾Sucrose fatty acid ester (HLB 16)
⁽²⁾Black chocolate FL: produced by San-Ei Gen F. F. I., Inc.

Note that Homogen (trademark registered in Japan) No. 7331P (produced by San-Ei Gen F. F. I., Inc.) is a stabilizer composed of the following constituents (the same applied in the Examples below)

TABLE 29

| Raw Materials | (%) | per 100 g beverage |
|---|---|---|
| San Artist PX | 29.1 | 0.25% |
| Emulsifier⁽¹⁾ | 7 | 0.06% |
| Emulsifier⁽²⁾ | 5.7 | 0.05% |
| Hydrous crystal glucose | 58.2 | 0.50% |
| Total volume adjusted with water | 100 | 0.86% |

⁽¹⁾Sucrose fatty acid ester (HLB 16)
⁽²⁾Organic acid monoglyceride (HLB 5.3)

### <Preparation Method>

(1) Add mixture of constituents 3, 4, 5, and 6 to ion-exchanged water (30 parts) at 80° C., heat and stir the mixture at 80° C. for 10 minutes, and then cool the mixture to 20° C. or lower.
(2) Add constituents 1 and 7 to (1), heat the mixture up to 70° C., and homogenize the mixture under the pressure of 10 MPa in the first stage, and under 5 MPa in the second stage.
(3) UHT-sterilize (plate type) the mixture at 140° C. for 45 seconds, and pour the obtained cocoa beverage into a PET bottle aseptically.

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 30.

TABLE 30

| | Foam state | Foam mobility | |
|---|---|---|---|
| Evaluation | in beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

### Example 33

### Matcha Beverage

According to the following formulation, Matcha beverages (pH 6.5) were prepared.

TABLE 31
<Formulation>

| | | Comparative ex. | Example |
|---|---|---|---|
| 1. | Matcha | 0.5 | 0.5 |
| 2. | Milk | 10 | 10 |
| 3. | Nonfat dry milk | 3 | 3 |
| 4. | Granulated sugar | 5 | 5 |
| 5. | Emulsifier⁽¹⁾ | 0.06 | — |
| 6. | Homogen No. 7331P | — | 0.86 |
| 7. | Flavor⁽²⁾ | 0.2 | 0.2 |

| | | |
|---|---|---|
| Total volume adjusted with water | 100 | 100 |

⁽¹⁾Sucrose fatty acid ester (HLB 16)
⁽²⁾Matcha enhancer NO. 78658: produced by San-Ei Gen F. F. I., Inc.

(1) Add mixture of constituents 3, 4, 5, and 6 to ion-exchanged water (30 parts) at 80° C., heat and stir the mixture at 80° C. for 10 minutes, and then cool the mixture to 20° C. or lower.
(2) Add constituents 1 and 7 to (1), heat the mixture up to 75 C, and homogenize the mixture under the pressure of 10 MPa in the first stage, and under 5 MPa in the second stage.
(3) After sterilization at 93° C., cause the mixture to be hot packed.

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 32.

TABLE 32

| | Foam state | Foam mobility | |
|---|---|---|---|
| Evaluation | in beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

### Example 34

### Banana Beverage

According to the following formulation, banana beverages (pH 6.5) were prepared.

TABLE 33
<Formulation>

| | | Comparative ex. | Example |
|---|---|---|---|
| 1. | Milk | 50.0 (%) | 50.0 (%) |
| 2. | Banana puree | 5 | 5 |
| 3. | Granulated sugar | 6 | 6 |
| 4. | Emulsifier⁽¹⁾ | 0.06 | — |
| 5. | Homogen NO. 7331P | — | 0.86 |
| 6. | Emulsifier⁽²⁾ | — | 0.03 |
| 7. | Antioxidant⁽³⁾ | 0.05 | 0.05 |
| 8. | Colorant⁽⁴⁾ | 0.1 | 0.1 |
| 9. | Flavor⁽⁵⁾ | 0.1 | 0.1 |

| | | |
|---|---|---|
| Total volume adjusted with water | 100 | 100 |

⁽¹⁾Sucrose fatty acid ester (HLB 16)
⁽²⁾quillaja extract
⁽³⁾San Melin AO-1007: produced by San-Ei Gen F. F. I., Inc.
⁽⁴⁾San Yellow NO. 2SFU: produced by San-Ei Gen F. F. I., Inc.
⁽⁵⁾Banana flavor NA-3509: produced by San-Ei Gen F. F. I., Inc.

### <Preparation Method>

(1) Add above mixture of powder constituents 3 to 5 to water, heat and stir the mixture at 80° C. for 10 minutes, and then cool the mixture to 20° C. or lower.
(2) Add constituents 1, 2, 6, and 7 to 9 to (1), heat the mixture up to 80° C., and homogenize the mixture under the pressure of 10 MPa in the first stage, and under 5 MPa in the second stage.
(3) After sterilization at 93° C., cause the mixture to be hot packed.

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 34.

TABLE 34

| | Foam state | Foam mobility | |
|---|---|---|---|
| Evaluation | in beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

### Example 35

### Fruit Juice Beverage

According to the following formulation, fruit juice beverages (pH 3.6) were prepared.

TABLE 35
<Formulation>

| | | Comparative ex. | Example |
|---|---|---|---|
| 1. | Fructose glucose syrup | 7.0 | 7.0 |
| 2. | Unshiu pulp A | 5.0 | 5.0 |
| 3. | Citrus mix juice | 10.0 | 10.0 |
| | (5 times concentrated) | | |
| 4. | Citric acid (anhydrous) | 0.1 | 0.1 |
| 5. | Trisodium citrate | 0.1 | 0.1 |
| 6. | San Artist PG | — | 0.7 |
| 6. | Emulsifier⁽¹⁾ | 0.03 | 0.03 |
| 7. | Flavor⁽²⁾ | 0.15 | 0.15 |
| 8. | Flavor⁽³⁾ | 0.05 | 0.05 |

| | | |
|---|---|---|
| Total volume adjusted with water | 100 | 100 |

⁽¹⁾quillaja extract
⁽²⁾Orange flavor NO. 21-B: produced by San-Ei Gen F. F. I., Inc.
⁽³⁾Lemon flavor NO. 21-B: produced by San-Ei Gen F. F. I., Inc.

### <Preparation Method>

(1) Pour water and constituents 1 and 3 into a container, then add mixture of powder constituents 4 to 6 thereto, and heat and stir the mixture at 80° C. for 10 minutes. After dissolution, cool the mixture.
(2) Add constituents 7 to 9 to (1), and add water to an amount of 95 parts.
(3) Heat the mixture up to 75° C., add water again so as to supplement evaporated water, and homogenize the mixture using a homogenizer under 9.8 MPa in the first stage, and under 4.9 MPa in the second stage.
(4) Add constituent 2 to the homogenized solution, heat the mixture up to 93° C., and cause the mixture to be subject to hot packing.

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 36.

TABLE 36

| | Foam state | Foam mobility | |
|---|---|---|---|
| Evaluation | in beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

### Example 36

### Coffee Beverage

According to the following formulation, coffee beverages (pH 6.8) were prepared.

TABLE 37
<Formulation>

| | | Comparative ex. | Example |
|---|---|---|---|
| 1. | Coffee solid content | 1.6 | 1.6 |
| 2. | Milk | 10 | 10 |
| 3. | Nonfat dry milk | 3 | 3 |
| 4. | Granulated sugar | 5 | 5 |
| 5. | Baking soda added so as to be pH | 6.8 | |
| 6. | Emulsifier⁽¹⁾ | 0.06 | — |
| 7. | H-7331P | — | 0.86 |
| 8. | Emulsifier⁽²⁾ | — | 0.03 |
| 9. | Flavor⁽³⁾ | 0.02 | 0.02 |

| | | |
|---|---|---|
| Total volume adjusted with water | 100 | 100 |

⁽¹⁾Sucrose fatty acid ester (HLB 16)
⁽²⁾quillaja extract
⁽³⁾Art Flavor (trademark registered in Japan ) Coffee NO. 96806: produced by San-Ei Gen F. F. I., Inc.

Note that H-7331P is a mixed preparation composed of the following constituents.

| Raw Materials | (%) | per 100 g beverage |
|---|---|---|
| San Artist PX | 29.1 | 0.25% |
| Emulsifier⁽¹⁾ | 7 | 0.06% |
| Emulsifier⁽²⁾ | 5.7 | 0.05% |
| Hydrous crystal glucose | 58.2 | 0.50% |
| Total volume adjusted with water | 100 | 0.86% |

⁽¹⁾Sucrose fatty acid ester (HLB 16)
⁽²⁾Organic acid monoglyceride (HLB 5.3)

### <Preparation Method>

(1) To ground coffee beans, pour hot water in an amount 6 times as much as the coffee, and immerse the coffee for 40 minutes, filter the mixture with filter paper (SM-45A produced by Azumi FilterPaper Co., Ltd.), and cool the filtered solution down to 20° C. or lower.
(2) Add mixture of constituents 3, 4, 6, and 7, in the above formulation, to ion-exchanged water (30 parts) at 80° C., heat and stir the mixture at 80° C. for 10 minutes. Then cool the mixture down to 20° C. or lower.
(3) Add constituents 2, 5, 1, 8, and 9 to the mixed liquid prepared in (2), and adjust the total volume with ion-exchanged water.
(4) Heat the mixed liquid obtained in (3) up to 75° C., and homogenize the mixture under 10 MPa in the first stage, and under 5 MPa in the second stage.
(5) UHT-sterilize (plate type) the mixture at 140° C. for 45 seconds, and pour the sterilized mixture to a PET bottle aseptically (pH 6.6 after sterilization; viscosity: 123 mPa·s for Example, 5.0 mPa·s for Comparative example).

### <Experimental Method>

In a similar manner to Example 30, stir respective beverages for foaming. Visually observe the foam in each beverage. In addition, pour each beverage from the measuring cylinder to a glass to observe the state of the foam moving. Further, drink the beverage and evaluate the mouthfeel.

Results are shown in Table 38.

TABLE 38

| | Foam state | Foam mobility | |
|---|---|---|---|
| Evaluation | in beverage | into glass | Mouthfeel |
| Comparative | Foam floated | Unable to | No mouthfeel |
| example | quickly | move into | of foam |
| | | glass but | |
| | | remained | |
| Example | Fine delicate | Moved into | Mouthfeel of |
| | foam remained | glass together | good texture |
| | clearly | with beverage | foam |

1. A method for enhancing a foam retention property of a beverage, the method comprising the step of:
preparing the beverage using a fermentation-derived cellulose as a raw material thereof.

2. The method for enhancing the foam retention property of the beverage according to claim 1, wherein the fermentation-derived cellulose is complexed a high molecular substance.

3. The method according to claim 2, wherein the high molecular substance is at least one kind selected from the group consisting of xanthan gum, guar gum, carboxymethylcellulose, and a carboxymethylcellulose salt.

4. The method according to claim 1, wherein the beverage is prepared using a frothing agent as the other raw material.

5. The method according to claim 1, wherein the beverage is prepared using an emulsifier as the other raw material.

6. The method according to claim 1, wherein the beverage is prepared using a polysaccharide as the other raw material.

7. The method according to claim 1, wherein the fermentation-derived cellulose is used such that concentration of the fermentation-derived cellulose is in an amount of 0.04 to 0.2 wt. % in the beverage.

8. The method according to claim 1, wherein the beverage is a milk components-containing beverage, or a fruit or a vegetable beverage.

9. A method for creating and retaining foam in a beverage, comprising the step of
shaking a container containing a beverage having a foam retention property enhanced based on the method according to claim 1, so as to create foam in the beverage.

10. A foaming beverage containing a fermentation-derived cellulose in a state of a complex with a high molecular substance, wherein by shaking a container containing the foaming beverage so as to create foam, the foam is stably retained within the foaming beverage as well as in a top layer of the foaming beverage.

11. The foaming beverage according to claim 10, further containing a frothing agent.

12. The foaming beverage according to claim 10, further containing an emulsifier.

13. The foaming beverage according to claim 10, further containing a polysaccharide.

14. The foaming beverage according to claim 10, wherein the fermentation-derived cellulose is contained in an amount of 0.04 to 0.2 wt. % in the foaming beverage.

15. The foaming beverage according to claim 10, wherein the foaming beverage is a milk components-containing beverage or a fruit or a vegetable beverage.

16. A method for creating and retaining foam in a beverage, comprising the step of
shaking a container containing a beverage having a foam retention property enhanced based on the method according to claim 2, so as to create foam in the beverage.

17. The method according to claim 16, wherein the high molecular substance is at least one kind selected from the group consisting of xanthan gum, guar gum, carboxymethylcellulose, and a carboxymethylcellulose salt.

18. A method for creating and retaining foam in a beverage, comprising the step of
shaking a container containing a beverage having a foam retention property enhanced based on the method according to claim 6, so as to create foam in the beverage.

19. A method for creating and retaining foam in a beverage, comprising the step of
shaking a container containing a beverage having a foam retention property enhanced based on the method according to claim 7, so as to create foam in the beverage.

20. A method for creating and retaining foam in a beverage, comprising the step of
shaking a container containing a beverage having a foam retention property enhanced based on the method according to claim 8, so as to create foam in the beverage.
